(19) United States
(12) Patent Application Publication
(10) Pub. No.: US 2023/0058198 A1
(43) Pub. Date: Feb. 23, 2023

(54) DYNAMIC CRYPTOGRAPHIC ALGORITHM SELECTION

(71) Applicant: VMware, Inc., Palo Alto, CA (US)

(72) Inventors: Sean HUNTLEY, NSW (AU); Akeem JENKINS, Broomfield, CO (US); Marc Wayne BROTHERSON, Boulder, CO (US); David OTT, Chandler, AZ (US)

(21) Appl. No.: 17/408,882

(22) Filed: Aug. 23, 2021

(51) Int. Cl. H04L 9/14; H04L 9/08; H04L 9/00; H04L 9/32

(52) U.S. Cl. CPC H04L 9/14; H04L 9/0825; H04L 9/008; H04L 9/3297

(57) ABSTRACT

The disclosure provides an approach for cryptographic agility. Embodiments include receiving, by a cryptographic agility system associated with an application, a request to establish a secure communication session. Embodiments include, prior to establishing the secure communication session, selecting, by the cryptographic agility system, a first cryptographic technique and a second cryptographic technique for the secure communication session. Embodiments include, during the secure communication session, utilizing the first encryption technique for securely communicating a first set of data. Embodiments include determining that a condition has been met for switching from the first encryption technique to the second encryption technique. Embodiments include, based on the determining that the condition has been met, utilizing the second encryption technique for securely communication a second set of data.

### BACKGROUND

Cryptography generally involves techniques for protecting data from unauthorized access. For example, data transmitted over a network may be encrypted in order to protect the data from being accessed by unauthorized parties. For example, even if the encrypted data is obtained by an unauthorized party, if the unauthorized party cannot decrypt the encrypted data, then the unauthorized party cannot access the underlying data. There are many types of cryptographic algorithms, and these algorithms vary in many aspects such as key size, ciphertext size, memory requirements, computation requirements, amenability to hardware acceleration, failure handling, entropy requirements, and the like. Key size refers to the number of bits in a key used by a cryptographic algorithm. Ciphertext size refers to the number of bits in the output from a cryptographic algorithm, which may be the same as the number of bits of the input or may include padding to produce a larger number of bits than the input. Memory requirements and computation requirements generally refer to the amount of memory and processing resources required to perform an algorithm. Amenability to hardware acceleration generally refers to whether an algorithm requires or can be improved through the use of a hardware accelerator. For example, a compute accelerator is an additional hardware or software processing component that processes data faster than a central processing unit (CPU) of the computer. Failure handling refers to the processes by which an algorithm accounts for failures, such as recovering keys that are lost or deactivated. Entropy requirements generally refer to the amount of randomness required by an algorithm, such as an extent to which randomly generated values are used as part of the algorithm (e.g., which generally improves security of the algorithm).

Some cryptographic algorithms may result in a higher level of security (e.g., having more bits of security, more layers of security, larger amounts of entropy, and/or the like) than others, and there may be trade-offs with respect to resource requirements such that higher-security algorithms may require larger amounts of storage, processing, and/or communication resources (e.g., involving the transmission of larger amounts of information over a network). Furthermore, new cryptographic algorithms and libraries are developed on an ongoing basis to meet changing security needs. Cryptographic libraries are collections of cryptographic algorithms that can be invoked, such as through calls to application programming interface (API) functions provided by the libraries, in order to perform various cryptographic functions (e.g., encryption of data, establishing secure connection channels, and/or the like). In some cases, weaknesses in particular algorithms may be discovered over time such as due to advances in computing technology (e.g., a particular algorithm may be susceptible to being compromised through the use of computing devices with more power than the computing devices that were in use at the time the algorithm was developed). For example, algorithms may become problematic and/or become less useful for a variety of reasons, such as due to algorithmic compromise (e.g., a weakness in the algorithm may be discovered and/or exploited), compute performance increases (e.g., the time required to “guess correctly” may be reduced), and/or the like. In some cases, new and/or updated algorithms may be developed to address these issues (e.g., by adding additional bits of security, additional layers of security, more complex forms of encryption, and/or the like).

The rise of quantum computing has raised the possibility of additional issues related to cryptography. For example, the high levels of computational power provided by quantum computing may enable nefarious actors to more easily access data secured with existing cryptographic algorithms, thereby gaining access to sensitive data that was previously believed to be secure.

The dynamic nature of computing technology and the variety of threats that exist to data security necessitate a continuous adapting of cryptography to meet these new circumstances and threats. Furthermore, laws and/or regulations may require certain types of cryptography to be utilized in certain contexts. Thus, compliance with such laws and/or regulations may further necessitate adopting of new and/or different types of cryptographic algorithms.

Conventional software applications are generally designed to implement and/or utilize particular cryptographic algorithms. These algorithms may be customizable in certain respects, but there is generally no convenient mechanism for changing the cryptographic algorithms utilized by an application without modifying the base code of the application, essentially requiring portions of the application code to be rewritten, which is time consuming and difficult. Such code modifications are expensive and error-prone, particularly when done on a regular basis to address the ever-changing landscape of computing security.

Furthermore, devices may have resource constraints that make it difficult or impossible to implement higher-security cryptographic algorithms (e.g., algorithms with a large number of bits of secuirty). For example, internet of things (IoT) devices may have limited power availability (e.g., due to battery constraints), and certain cryptographic techniques may be prohibitively power-intensive for use on such devices. As such, with conventional cryptographic techniques, security may need to be sacrificed for the sake of device performance.

As such, there is a need for improved cryptography techniques that allow for cryptographic agility, particularly in way that improves security of cryptography performed on devices with more restrictive resource constraints.

### BRIEF DESCRIPTION OF THE DRAWINGS

FIG. 1 is an illustration of example computing components related to cryptographic agility, according to embodiments of the present disclosure.

FIG. 2 is an illustration of an example secure communication session related to dynamic cryptographic technique selection.

FIG. 3 is an illustration of an example of communications related to dynamic cryptographic technique selection.

FIG. 4 depicts example operations related to dynamic cryptographic technique selection according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to cryptographic agility. In particular, the present disclosure provides an approach for dynamic cryptographic technique selection, including planned switching among multiple cryptographic techniques within a secure communication session.

Cryptographic agility generally refers to techniques for dynamic selection and/or configuration of cryptographic algorithms. According to certain embodiments, logic related to selection and/or configuration of cryptographic algorithms is decoupled from the applications that utilize cryptographic functionality, and is implemented in one or more separate components. Thus, rather than an application directly calling a cryptographic library to perform cryptographic functionality, the application may call generic cryptographic functions provided by a separate cryptographic agility system, and the cryptographic agility system may then select and/or configure cryptographic algorithms, such as based on contextual information and/or policies. For instance, the cryptographic agility system may dynamically determine which libraries, algorithms, configuration values, and/or the like to select based on factors such as the type of data being encrypted, the type of application requesting encryption, the network environment(s) in which the data is to be sent, a destination to which encrypted data is to be sent, geographic locations associated with a source and/or destination of the data, attributes of users associated with the encryption, regulatory environments related to the encryption, network conditions, resource availability, performance constraints, device capabilities, and/or the like.

Dynamically selecting cryptographic techniques based on resource constraints is described in more detail in U.S. patent application Ser. No. 17/385,287, filed Jul. 26, 2021, the contents of which are incorporated by reference herein in their entirety.

In some embodiments, a proxy component may be utilized to enable cryptographic agility in legacy applications and services. Such a proxy component is described in more detail in U.S. patent application Ser. No. 17/385,401, filed Jul. 26, 2021, the contents of which are incorporated by reference herein in their entirety.

In certain embodiments, records of operations related to cryptographic agility may be written to a secure ledger for auditability. The use of such as secure ledger for auditable cryptographic agility is described in more detail in U.S. patent application Ser. No. 17/385,489, filed Jul. 26, 2021, the contents of which are incorporated by reference herein in their entirety.

For example, policies may be defined by users (e.g., administrators), and may specify rules for selecting and/or configuring cryptographic algorithms and corresponding certificates. In one example, cryptographic techniques (e.g., algorithms and/or configurations of algorithms) are tagged with different levels of security (e.g., rated from 0-10), and a policy associated with an application may specify that all data that is to be transmitted from the application to a destination in a given type of networking environment, such as a public network, is to be encrypted using a high-security algorithm (e.g., rated 8 or higher). Thus, if the application sends data (e.g., whether encrypted directly by the application or not) that is intercepted by the proxy component, and contextual information indicates that the data is to be transmitted to a device on a public network, then the cryptographic agility system, in certain embodiments, will select one or more cryptographic techniques tagged as high-security techniques, such as with a security rating of 8 or higher.

According to embodiments of the present disclosure, cryptographic techniques may be rotated or otherwise changed within a secure communication session (e.g., a secure connection between two endpoints that is not interrupted by a disconnect or ending of the secure connection), such as to increase security without requiring the use of cryptographic algorithms that have high resource requirements. For example, in response to a request to establish a secure connection with an endpoint on behalf of an application, the cryptographic agility system selects a plurality of cryptographic techniques for use (e.g., according to a rotation pattern) for the secure connection. In some embodiments, the cryptographic agility system negotiates with the endpoint to select the cryptographic agility techniques, such as by receiving a list from the endpoint of all cryptographic techniques supported by the endpoint. The cryptographic agility system may then select the plurality of cryptographic techniques from the list of techniques supported by the endpoint. Furthermore, the selection of the plurality of cryptographic techniques may be based on one or more policies, contextual information, resource constraints, and/or the like. In one embodiment, the cryptographic agility system determines to select a plurality of cryptographic techniques rather than a single cryptographic technique based on resource constraints of one or more devices and/or networks related to a cryptographic request. For example, multiple cryptographic techniques with low power requirements (e.g., tagged with power resource requirements below a threshold) may be selected if the cryptographic request relates to a device with low power availability (e.g., an IoT device).

A rotation pattern may indicate a pattern with which the selected cryptographic algorithms are to be utilized within the secure communication session. For instance, the rotation pattern may indicate an ordering of the cryptographic techniques, conditions for switching between the cryptographic techniques, and/or the like. Conditions for switching from one cryptographic technique to another may include, for instance, time intervals, threshold amounts of data being communicated, characteristics of data being communicated, contextual information such as resource availability, receiving user input indicated that a switch should occur, and/or the like.

In some embodiments, keys for all of the cryptographic techniques to be utilized in a rotation (e.g., a single iteration of each of the cryptographic techniques) are determined prior to the first rotation and provided to the endpoint in advance, such as to frontload processing, communication, and/or power utilization involved in key determination and transmission, thereby reducing latency during the rotation. In other embodiments, the key for each given cryptographic technique is determined and/or provided to the endpoint immediately before the given cryptographic technique is utilized in the rotation. In some embodiments, new keys for each cryptographic technique are determined at the beginning of each new rotation, while in other embodiments the same keys are used across multiple rotations.

In some embodiments, the plurality of cryptographic techniques used in a rotation include multiple different cryptographic algorithms and/or configurations, while in other embodiments the plurality of cryptographic techniques used in a rotation include multiple instances of the same cryptographic algorithm and/or configuration with different keys. Certain embodiments involve selecting new cryptographic techniques and/or a new ordering of cryptographic techniques at the beginning of each new rotation, rather than repeating the same pattern in each rotation.

In some cases, the cryptographic agility system may provide the endpoint with information that allows the endpoint to determine when each given cryptographic technique is being utilized. For example, the cryptographic agility system may provide the endpoint with the ordering of cryptographic techniques and the switch condition. In another example, the cryptographic agility system may send a signal indicating a switch every time a switch in cryptographic techniques occurs and/or may send a signal indicating a new rotation every time a new rotation begins.

Determinations of whether to use multiple cryptographic techniques, whether to front-load determination and/or transmission of keys, whether to use the same or different keys and/or cryptographic techniques across rotations, which switch conditions to utilize, and/or the like may be based on one or more policies and/or based on contextual information. For example, a policy may indicate that when contextual information indicates certain resource constraints and/or types of data, that a set number of cryptographic techniques having certain characteristics are to be utilized in a repeating pattern, that a given time interval is to be used as the switch condition, that determination and transmission of keys is to be frontloaded, and/or that the same keys are to be used in each rotation.

Users may be enabled to provide input that causes changes in a pattern, such as switching between cryptographic techniques, beginning a new rotation, determining new keys, removing a cryptographic technique from the pattern, selecting a new set of cryptographic techniques, and/or the like. For example, if an application or network administrator determines that a security threat may be present and/or that information related to a particular cryptographic technique may be compromised, the administrator may provide input that causes the cryptographic agility system to change the pattern in one or more ways.

By decoupling cryptographic logic from applications that rely on cryptographic functionality, techniques described herein provide flexibility and extensibility, thus allowing cryptographic algorithms to be continually updated, changed, and otherwise configured without requiring modifications to the applications themselves. Accordingly, changing circumstances and new threats may be addressed in a dynamic and efficient manner, and computing security may thereby be improved.

In some cases, cryptographic algorithms and/or configurations of algorithms may be dynamically switched over time based on changing circumstances, with or without such a change being part of a planned pattern. Such dynamic switching may occur within an ongoing cryptographic session between two endpoints. For example, if a client device moves from a low-latency network to a high-latency network (such as the latency of a network that device is coupled to changes), the cryptographic agility system may switch from a cryptographic technique that requires a large amount of network resources to an alternative cryptographic technique that requires smaller amounts of network resources (e.g., a lower security algorithm that still meets the security requirements for the cryptographic operation), and may switch back if the device moves again into a lower-latency network. These changing circumstances may be determined by the cryptographic agility system based on contextual information related to each communication from the application to the client device and vice-versa. As cryptographic techniques are switched, in certain embodiments, the cryptographic agility system also dynamically switches certificates accordingly. For example, if the cryptographic agility system switches from a first cryptographic technique to a second cryptographic technique, the cryptographic agility system may also obtain or generate a corresponding certificate for use with the second cryptographic technique, and provide the corresponding certificate to a requesting entity (e.g., application or proxy component) for use in authenticating a key.

Information related to utilizing multiple cryptographic techniques in a secure communication session may be recorded in a secure ledger, such as a block chain, for auditing purposes. For instance, information about patterns, switching of cryptographic techniques and/or keys, contextual information and/or policies related to such patterns and/or switches, and/or the like may be written to the secure ledger. Thus, these operations performed by the cryptographic agility system may be audited based on the records written to the secure ledger, such as to ensure compliance with one or more standards.

Embodiments of the present disclosure improve upon conventional cryptography techniques in which cryptographic algorithms are pre-determined for applications (e.g., at design time) by allowing cryptographic algorithms and/or configurations to be dynamically selected and changed over time based on contextual information, even if an application was not designed to support such functionality. Furthermore, cryptographic agility techniques described herein allow deprecated cryptographic techniques to be dynamically and efficiently removed from use without requiring any changes to underlying applications.

Additionally, techniques described herein may facilitate an organization's use of uniform policy configuration (e.g., a suite of coordinated policies), such as to orchestrate cryptographic usage across many hosts (e.g., for federated data centers deployed worldwide). Embodiments of the present disclosure may also be used to facilitate migration to new cryptographic algorithms at scale and/or to remove deprecated cryptographic algorithms from use in a centralized and coordinated manner.

Utilizing multiple cryptographic techniques within a secure communication session, such as according to a pattern, improves upon conventional cryptography systems by allowing for improved security without a substantial increase in resource requirements. For example, if a device has limited resource availability, multiple cryptographic techniques with lower resource requirements may be utilized in a pattern within a secure communication session in order to reduce the likelihood that data communicated during the secure communication session is compromised. Such techniques may be particularly beneficial for data that is long-lived, meaning that its sensitivity lasts for an extended amount of time. Diversifying the cryptography utilized in a secure communication session increases the amount of time required for an attacker to “crack” the cryptography (e.g., correctly guess the keys), as the attacker would be required to crack all of the cryptographic techniques in the pattern in order to gain access to all of the data communicated during the secure communication session.

It is noted that while embodiments described herein involve a cryptographic agility system that is decoupled from an application, alternative embodiments may involve an application directly utilizing multiple cryptographic techniques, such as according to a pattern, within a single secure communication session, without relying on a separate cryptographic agility system. For example, an application may be designed to natively provide such functionality. Thus, in some embodiments, a “cryptographic agility system associated with an application” may refer to the native cryptographic functionality of the application itself

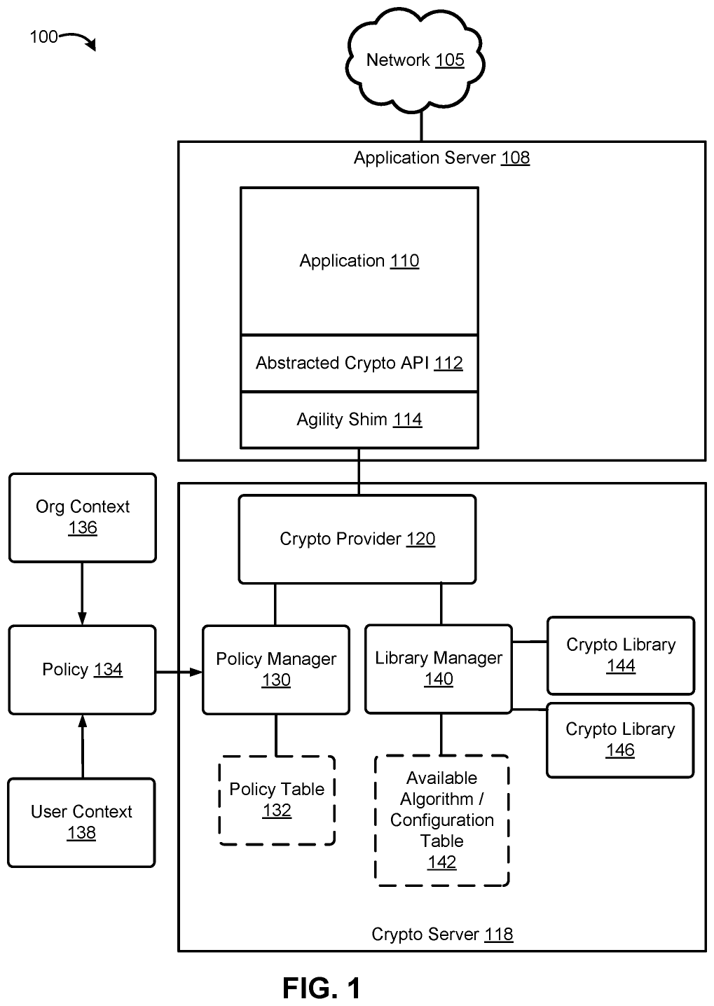

FIG. 1 is an illustration 100 of example computing components related to cryptographic agility, according to embodiments of the present disclosure.

An application server 108 is connected to a network 105. In certain embodiments, application server 108 may be a physical or virtual computing device, such as a server computer, that hosts an application 110. In some embodiments, application server 108 may be a virtual computing instance (VCI), such as a virtual machine (VM) or container that runs on a physical host computer. Network 105 may be any sort of network over which data may be transmitted, such as a local area network (LAN), cellular network, satellite-based network, the Internet, or the like. It is noted that application server 108 is included as an example computing device on which application 110 and/or associated components may be located, and other types of devices may also be used.

Application 110 generally represents a software application that requires cryptographic functionality. For example, application 110 may rely on cryptographic functionality to encrypt data that it transmits over a network (e.g., network 105), such as to one or more client devices that interact with application 110 (e.g., accessing content provided by application 110). While conventional techniques generally involve direct integration of cryptographic libraries with applications that rely on cryptographic functionality, techniques described herein involve abstracting cryptographic functionality away from applications. As such, an agility shim 114 provides an abstracted crypto application programming interface (API) 112 as a means of facilitating cooperation between application 110 and a separate cryptographic agility system. In some embodiments, agility shim 114 may be located within a proxy component that intercepts communications between application 110 and external endpoints such as client devices.

Application 110 or the proxy component may call generic cryptographic functions of abstracted crypto API 112 in order to invoke particular cryptographic functionality, and the cryptographic agility system may select cryptographic techniques and perform cryptographic operations in response to the function invocations based on contextual information.

The cryptographic agility system includes agility shim 114 and abstracted crypto API 112 as well as crypto provider 120, policy manager 130, library manager 140, and certificate manager 150. In some embodiments, while depicted as separate components, agility shim 114, abstracted crypto API 112, policy manager 130, library manager 140, and/or certificate manager 150 may be part of crypto provider 120. In certain embodiments, abstracted crypto API 112 and/or agility shim 114 are part of a proxy component located on application server 108. In alternative embodiments, abstracted crypto API 112 and/or agility shim 114 may be located on a proxy component separate from application server 108, such as on crypto server 118 or a different computing device.

Agility shim 114 may comprise a library, and generally intercepts API calls (e.g., calls to functions of abstracted crypto API 112) and redirects them to crypto provider 120. Shims generally allow new software components to be integrated with existing software components by intercepting, modifying, and/or redirecting communications. As such, agility shim 114 allows application 110 or a proxy component associated with application 110 to interact with crypto provider 120 even though the proxy component and/or application 110 itself may have no knowledge of crypto provider 120. For instance, application 110 or the proxy component may make generic cryptographic function calls (e.g., requesting that an item of data be encrypted), and these generic function calls may be intercepted by agility shim 114 and redirected to crypto provider 120.

It is noted that while embodiments of the present disclosure are depicted on application server 108 and crypto server 118, alternative embodiments may involve various components being located on more or fewer computing devices. In some cases, aspects of the cryptographic agility system may be implemented in a distributed fashion across a plurality of computing devices. In certain embodiments, said components may be located on a single computing device.

In certain embodiments, crypto server 118 comprises a physical or virtual computing device, such as a server computer, on which components of the cryptographic agility system, such as crypto provider 120, policy manager 130, library manager 140, and/or certificate manager 150, reside. For example, crypto server 118 may represent a VCI or a physical computing device. Crypto server 118 may be connected to network 105 and/or one or more additional networks.

Crypto provider 120 generally performs operations related to dynamically selecting cryptographic techniques and corresponding certificates (e.g., based on contextual information related to requests for cryptographic operations), performing the requested cryptographic operations according to the selected techniques, and providing results of the operations to the requesting components. Cryptographic techniques may include cryptographic algorithms (e.g., included in one or more libraries) and/or specific configurations of cryptographic algorithms, as described herein. In some embodiments, the cryptographic agility system is located on the same device as application 110, while in other embodiments the cryptographic agility system is located on a separate device, such as on a server that is accessible over a network.

In certain aspects, crypto provider 120 has two major subsystems, policy manager 130 and library manager 140. Policy manager 130 performs operations related to cryptographic policies, such as receiving policies defined by users and storing information related to the policies in a policy table 132. In an example, a policy 134 is based on one or more of an organizational context 136 and a user context 138 related to a cryptographic request.

Organizational context 136 may involve geographic region (e.g., country, state, city and/or other region), industry mandates (e.g., security requirements of a particular industry, such as related to storage and transmission of medical records), government mandates (e.g., laws and regulations imposed by governmental entities, such as including security requirements), and the like. For instance, policy 134 may indicate that if a cryptographic request is received in relation to a device (e.g., client device or other device, such as application server 108) associated with a particular geographic region, associated with a particular industry, and/or within the jurisdiction of a particular governmental entity, then crypto provider 120 must select one or more cryptographic techniques that meet one or more conditions (e.g., having a particular security rating and/or being configured to protect against particular types of threats) in order to comply with relevant laws, regulations, or mandates.

User context 138 may involve user identity (e.g., a user identifier or category, which may be associated with particular privileges), data characteristics (e.g., whether the data is sensitive, classified, or the like), application characteristics (e.g., whether the application is a business application, an entertainment application, or the like), platform characteristics (e.g., details of an operating system), device characteristics (e.g., hardware configurations and capabilities of the device, resource availability information, and the like), device location (e.g., geographic location information, such as based on a satellite positioning system associated with the device), networking environment (e.g., a type of network to which the device is connected, such as a satellite or land-based network connection), and/or the like. For example, policy 134 may indicate that if a cryptographic request is received in relation to a particular category of user (e.g., administrators, general users, or the like), relating to a particular type of data (e.g., tagged as sensitive or meeting characteristics associated with sensitivity, such as being financial or medical data), associated with a particular application or type of application, associated with a particular platform (e.g., operating system), associated with a device with particular capabilities or other attributes (e.g., a client or server device having a certain amount of processing or memory resources, or having an accelerator), and/or in relation to a device in a particular location (e.g., geographic location) or type of networking environment (e.g., cellular network, satellite-based network, land network, or the like), then crypto provider 120 should select one or more cryptographic techniques that meet one or more conditions. In some cases, a policy 134 may relate to resource constraints (e.g., based on available processing, memory, or network resources), such as specifying that cryptographic techniques must be selected based on resource availability (e.g., how much of a device's processing and/or memory resources are currently utilized, how much latency is present on a network, and the like) and/or capabilities (e.g., whether a device is associated with an accelerator) associated with devices and/or networks, while in other embodiments crypto provider 120 selects cryptographic techniques based on resource constraints independently of policy manager 130 (e.g., for all cryptographic requests regardless of whether any policies are in place). For example, policies may only relate to security levels of cryptographic techniques, such as requiring the use of cryptographic techniques associated with particular security ratings when certain characteristics are indicated in contextual information related to a cryptographic request, and resource constraints may be considered separately from policies. In one example, once all cryptographic techniques meeting the security requirements for a cryptographic request are identified based on policies, one or more cryptographic techniques are selected from these policy-compliant cryptographic techniques based on resource constraints.

Policy table 132 stores information related to policies, such as policy 134. In some embodiments, policy table 132 maps various contextual conditions (e.g., relating to organizational context 136 and/or user context 138) to cryptographic technique characteristics (e.g., security ratings, threats protected against, resource utilization ratings, and the like). For example, a contextual condition may be the use of a certain type of application, a certain type of data, or a particular geographic location. A cryptographic technique characteristic may be, for example, a security rating (e.g., 0-10), whether the cryptographic technique is quantum-safe, what level of resource requirements the cryptographic technique has for a particular type of resource (e.g., memory, processor, or network resources), or the like. Thus, when cryptographic requests are received, policy table 132 is used to determine whether the cryptographic requests are associated with any characteristics included in policies and, if so, what cryptographic technique characteristics are required by the policies for servicing the requests. Furthermore, policies stored in policy table 132 may indicate conditions (e.g., indicated by contextual data) under which multiple cryptographic techniques should be utilized, and/or under which particular types of patterns (e.g., number of cryptographic techniques, switch conditions, and/or the like) are to be utilized within a secure communication session.

Library manager 140 generally manages cryptographic libraries containing cryptographic algorithms. For example crypto libraries 144 and 146 each include various cryptographic algorithms, each of which may include configurable parameters, such as key size or ciphertext size. For instance, cryptographic techniques (e.g., algorithms and/or specific configurations of algorithms) may be registered with library manager 140 along with information indicating characteristics of the cryptographic techniques. Examples of algorithms include data encryption standard (DES), triple DES, advanced encryption standard (AES), and Rivest-Shamir-Adleman (RSA). An algorithm may, for example, involve symmetric key encryption or asymmetric key encryption. A configuration of an algorithm may include values for one or more configurable parameters of the algorithm, such as key size, size of lattice, which elliptic curve is utilized, number of bits of security, whether accelerators are used, ciphertext size, and/or the like. A characteristic of a cryptographic technique may be, for example, a security rating, a resource requirement rating, whether the technique requires an accelerator, whether the technique is quantum-safe, or the like. A cryptographic technique may include more than one cryptographic algorithm and/or configuration. In an example, each cryptographic technique is tagged (e.g., by an administrator) based on characteristics of the technique, such as with a security rating, an indication of threats protected against by the technique, indications of the resource requirements of the technique, and/or the like.

Information related to cryptographic techniques registered with library manager 140 is stored in available algorithm/configuration table 142. For instance, available algorithm/configuration table 142 may store identifying information of each available cryptographic technique (e.g., an identifier of a library, an identifier of an algorithm in the library, and/or one or more configuration values for the algorithm) associated with tags indicating characteristics of the technique. It is noted that policies and tags are examples of how cryptographic techniques may be associated with indications of characteristics, and alternative implementations are possible. For instance, rather than associating individual cryptographic techniques with tags, alternative embodiments may involve associating higher-level types of cryptographic techniques with tags, and associating individual cryptographic techniques with indications of types. For example, a higher-level type of cryptographic technique may be “symmetric key encryption algorithms configured with a key size of 200 bits or larger.” Thus, if tags are associated with this type (e.g., including security ratings, recourse requirement ratings, and the like), any specific cryptographic techniques of this type (being symmetric key encryption algorithms, and being configured with a key size of 200 bits or more) will be considered to be associated with these tags. In another example, fuzzy logic and/or machine learning techniques may be employed, such as based on historical cryptographic data indicating which cryptographic techniques were utilized for cryptographic requests having particular characteristics.

By allowing cryptographic techniques and libraries to be registered and deregistered with library manager 140 on an ongoing basis, embodiments of the present disclosure allow the pool of possible cryptographic techniques to be continuously updated to meet new conditions and threats. For example, as new libraries are developed, these libraries may be added to library manager 140, and the cryptographic techniques in the library may be used by crypto provider 120 in servicing requests from application 110 without application 110 having any awareness of the new libraries. Similarly, by managing policies and libraries separately, policies may be defined in an abstract manner (e.g., based on characteristics of requests and cryptographic techniques) such that policies may be satisfied through the selection of new cryptographic techniques that were not known at the time of policy creation. In one particular example, a new cryptographic technique is tagged as quantum safe, meaning that the cryptographic technique was developed to be resistant to being decoded by quantum computers. For instance, the new cryptographic technique may have a high security rating (e.g., 10 out of 10) as well as high resource requirements. The new cryptographic technique is registered with library manager 140, and information about the new cryptographic technique and its characteristics is stored in available algorithm/configuration table 142. Thus, the new cryptographic algorithm is available to be selected by crypto provider 120 for servicing cryptographic requests from the proxy component related to application 110.

Continuing with the example, a policy 134 states that cryptographic requests relating to data that is long-lived (e.g., of a type that must be protected over a long amount of time, such as many years) is to be encrypted using a quantum-safe cryptographic technique if such a technique is available, unless device and/or network resource constraints prohibit the use of such a technique. Long-lived data may include, for example, classified government data, certain types of personally-identifiable information, and the like. Data that is not long-lived may include, for example, a code or password that expires after a short amount of time, a credit card number that is updated at regular intervals, network configuration data that changes on a regular basis, and the like. A policy 134 may also state that if a cryptographic request relates to long-lived data but resource constraints prohibit the use of a technique tagged as quantum-safe, then a combination of cryptographic techniques with resource requirements consistent with the resource constraints should be utilized, such as in a repeating pattern.

Thus, when the proxy component related to application 110 submits a cryptographic request (e.g., via a call to a generic cryptographic function provided by abstracted crypto API 112) to encrypt an item of long-lived data (e.g., received from application 110 and directed to an endpoint), crypto provider 120 determines based on information stored in policy table 132 that a quantum-safe cryptographic technique is to be used if possible, or otherwise to use a combination of cryptographic techniques. Crypto provider 120 determines based on information in available algorithm/configuration table 142 that the new cryptographic technique is quantum-safe. Next, crypto provider 120 analyzes resource constraints related to the cryptographic request to determine if the new cryptographic technique can be performed. If crypto provider 120 determines that the device and/or network associated with application 110 can support the new cryptographic technique (e.g., based on available resources), then crypto provider 120 selects the new cryptographic technique for servicing the cryptographic request, and provides a response to application 110 or the proxy component (e.g., via agility shim 114) accordingly. Alternatively, if crypto provider 120 determines that the device and/or network associated with application 110 cannot support the new cryptographic technique (e.g., based on available resources), then crypto provider 120 selects a plurality of cryptographic techniques consistent with the available resources of the device and/or network for servicing the cryptographic request according to a pattern, and provides a response to application 110 or the proxy component (e.g., via agility shim 114) accordingly. In some cases, the response sent from crypto provider 120 to application 110 or the proxy component includes data encrypted using the selected technique(s). In other cases, the response includes information related to performing the selected technique(s) to encrypt the data, and the encryption is performed by the entity from which the request was sent.

In some cases, more than one cryptographic technique may be selected for servicing a given cryptographic request together, without utilizing a pattern. For instance, an item of data may first be encrypted using a first technique (e.g., that satisfies one or more first conditions related to policy and/or resource considerations) and then the encrypted data may be encrypted again using a second technique (e.g., that satisfies one or more second conditions related to policy and/or resource considerations).

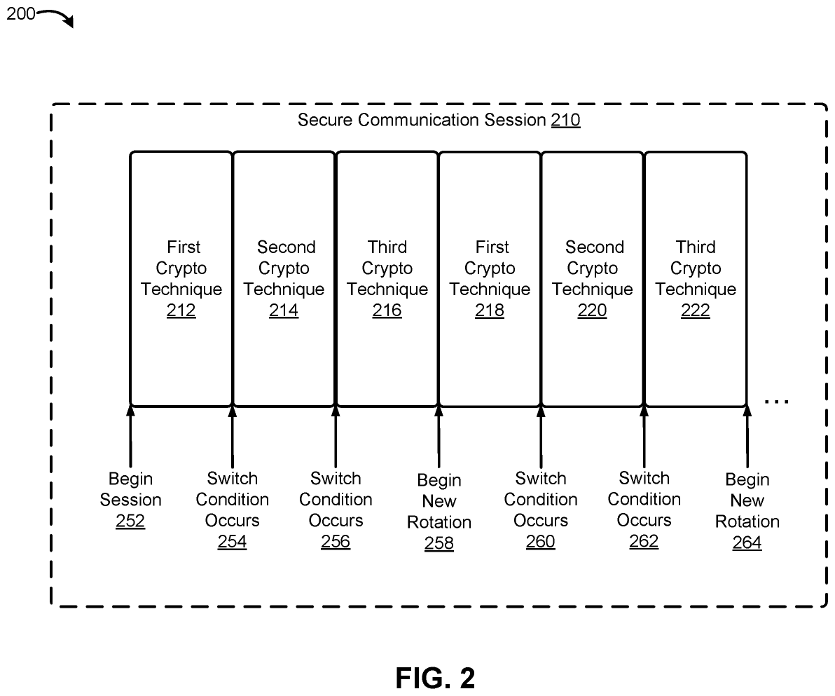

FIG. 2 is an illustration 200 of an example secure communication session 210 related to dynamic cryptographic technique selection. For example, secure communication session 210 may involve the use of a plurality of cryptographic techniques selected by crypto provider 120 of FIG. 1, according to a pattern, to service a cryptographic request relating to application 110 of FIG. 1.

Secure communication session 210 represents a single session of communication between an application and an endpoint (e.g., without being interrupted by a disconnection or other condition that would otherwise require a re-negotiation of cryptographic techniques). A first crypto technique 212, a second crypto technique 214, and a third crypto technique 216 are utilized in a rotating pattern within secure communication session 210. For instance, crypto provider 120 of FIG. 1 may have selected first crypto technique 212, second crypto technique 214, and third crypto technique 216 based on one or more policies and/or contextual information, such as resource constraints. In one example, first crypto technique 212, second crypto technique 214, and third crypto technique 216 are each tagged with resource requirements that are consistent with resource constraints related to the cryptographic request, and are used in a pattern to encrypt data sent between the application and the endpoint. Details of the pattern may be determined by crypto provider 120 of FIG. 1, such as based on one or more policies.

At point 252, secure communication session 210 begins. In some embodiments, keys for first crypto technique 212, second crypto technique 214, and third crypto technique 216 are determined at or before point 252 and, in some embodiments, sent to the endpoint before any encrypted data is sent. In other embodiments, only a key for first crypto technique 212 is determined at or before point 252.

After point 252, a first rotation begins with utilizing first crypto technique 212 for encrypting data. At point 254, a switch condition occurs. The switch condition may be, for example, a time interval elapsing, a threshold amount of data being communicated, a characteristic of data being identified (e.g., data requiring a higher level of security may be detected), a change in contextual information (e.g., a device moving from one network to another network with different characteristics), user input, and/or the like. In some embodiments, upon a switch condition occurring (e.g., at point 254 and otherwise), a signal is sent to the endpoint indicating that a switch is taking place. Alternatively, the endpoint may determine on its own that the switch condition has occurred. Upon the switch condition occurring, the second crypto technique 214 is utilized to encrypt a next set of data. If all keys for the rotation were not determined in advance, then a key for second crypto technique 214 may be determined after the switch condition occurs at 254, and may be sent to the endpoint prior to sending data encrypted using the second crypto technique 214.

At point 256, another switch condition occurs. At this point, third crypto technique 216 is utilized. If all keys for the rotation were not determined in advance, then a key for third crypto technique 216 may be determined after the switch condition occurs at 256, and may be sent to the endpoint prior to sending data encrypted using the third crypto technique 216.

At point 258, the first rotation ends and a second rotation begins. For example, another switch condition may occur and, since all of the cryptographic techniques in the rotation have been utilized, this may indicate that a new rotation is to begin. In some embodiments, new keys are determined for first crypto technique 212, second crypto technique 214, and third crypto technique 216 for the second rotation, while other embodiments involve using the same keys for the second rotation. It is noted that, while illustration 200 depicts the same cryptographic techniques being utilized in the same order in the second rotation, other embodiments may involve selecting new cryptographic techniques or changing the order of the cryptographic techniques for the second rotation.

During the second rotation, first crypto technique 212, second crypto technique 214, and third crypto technique 216 are again utilized, with switches taking place when switch conditions occur at points 260 and 262. At point 264, the second rotation ends (e.g., upon the occurrence of a switch condition after all of the cryptographic techniques in the rotation have been utilized) and a third rotation begins.

It is noted that switch conditions may all be the same, or multiple switch conditions may be utilized. For example, a switch may occur whenever one of a plurality of switch conditions occurs, such as a time interval elapsing, a threshold amount of data being communicated, and/or the like. In some embodiments, different switch conditions are used to determine when to switch to individual cryptographic techniques. For example, a particular switch condition may indicate that a particular cryptographic technique is to be utilized when a certain type of data is encountered (e.g., high-security data, long-lived data, and/or the like). For example, a first cryptographic technique may be utilized for general content related to an application, but a switch to a second (e.g., more secure) cryptographic technique may be performed if particular types of data (e.g., passwords) are encountered.

It is noted that secure communication session 210 is included as an example, and other combinations and/or patterns of cryptographic techniques may be utilized, including more or fewer cryptographic techniques. Furthermore, in some embodiments, ordering of cryptographic techniques may vary between rotations. In one example, random ordering is used, and a signal is sent to the endpoint upon each occurrence of a switch condition indicating which cryptographic technique will be utilized next and/or including a key for the cryptographic technique that will be used next.

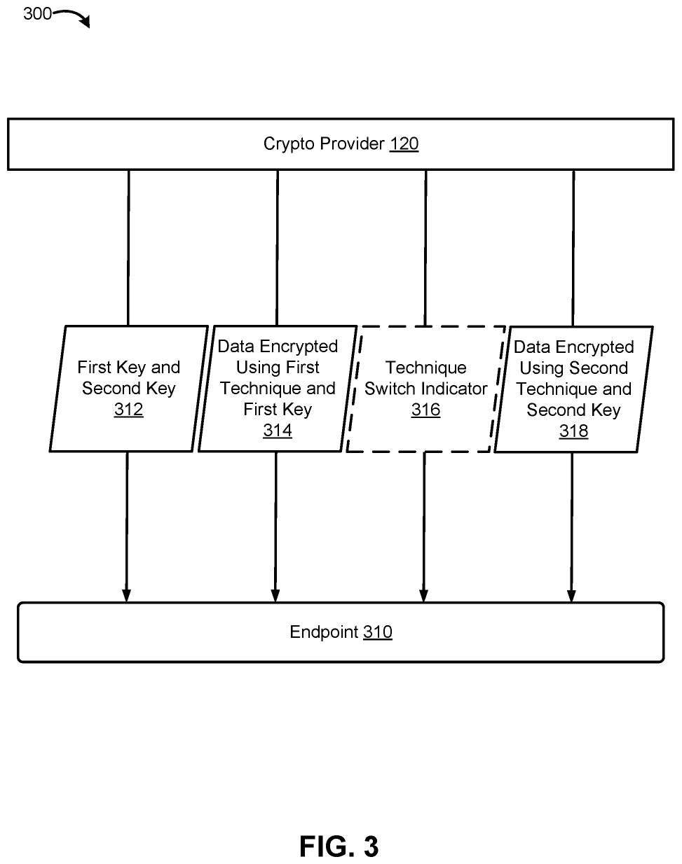

FIG. 3 is an illustration 300 of an example of communications related to dynamic cryptographic technique selection. Illustration 300 includes crypto provider 120 of FIG. 1.

At 312, crypto provider 120 sends a first key and a second key to an endpoint 310. For example, crypto provider 120 may have received a request to establish a secure connection on behalf of an application (e.g., application 110 of FIG. 1) with endpoint 310, which may be a client device that is requesting data from the application (e.g., which may be running on a server). Thus, crypto provider 120 selects a first cryptographic technique and a second cryptographic technique for servicing the request in a repeating pattern, such as based on one or more policies and/or based on contextual data related to the cryptographic request. Crypto provider 120 may have determined the first key for the first cryptographic technique and the second key for the second cryptographic technique prior to sending any encrypted data via the secure connection, sending both keys in advance to endpoint 310. In alternative embodiments, crypto provider 120 determines and/or sends the second key at a later point, such as prior to sending data encrypted using the second technique.

In some embodiments, crypto provider 120 also provides endpoint 310 with information about the pattern, such as which cryptographic techniques will be utilized, an order in which the cryptographic techniques will be utilized, and/or one or more switch conditions.

At 314, crypto provider 120 sends data encrypted using the first technique and the first key to endpoint 310. Endpoint 310 may decrypt the data using the first key sent at 312.

At 316, crypto provider 120 optionally sends a technique switch indicator to endpoint 310. For example, the technique switch indicator may be one or more bits included in a message that indicate that a switch is occurring and, in some embodiments, which technique is being switched to. Alternatively, endpoint 310 may determine on its own that a switch is occurring or has occurred, such as based on its own knowledge of a switch condition or based on its own analysis of the data being sent (e.g., by attempting to decrypt received data with the first key and determining that the data has been encrypted with a different key and/or technique due to the decrypted data being unintelligible).

At 318, crypto provider 120 sends data encrypted using the second cryptographic technique and the second key to endpoint 310. Endpoint 310 may decrypt the data using the second key.

The example depicted in illustration 300 is included as one example, and alternative embodiments are possible. For example, in some embodiments crypto provider 120 does not send encrypted data to endpoint 310 directly, and the application to which the data relates receives the encrypted data or information related to encryption techniques from crypto provider 120, and sends the encrypted data to endpoint 310. In other embodiments, a proxy component sends encrypted data to endpoint 310 on behalf of the application and/or crypto provider 120.

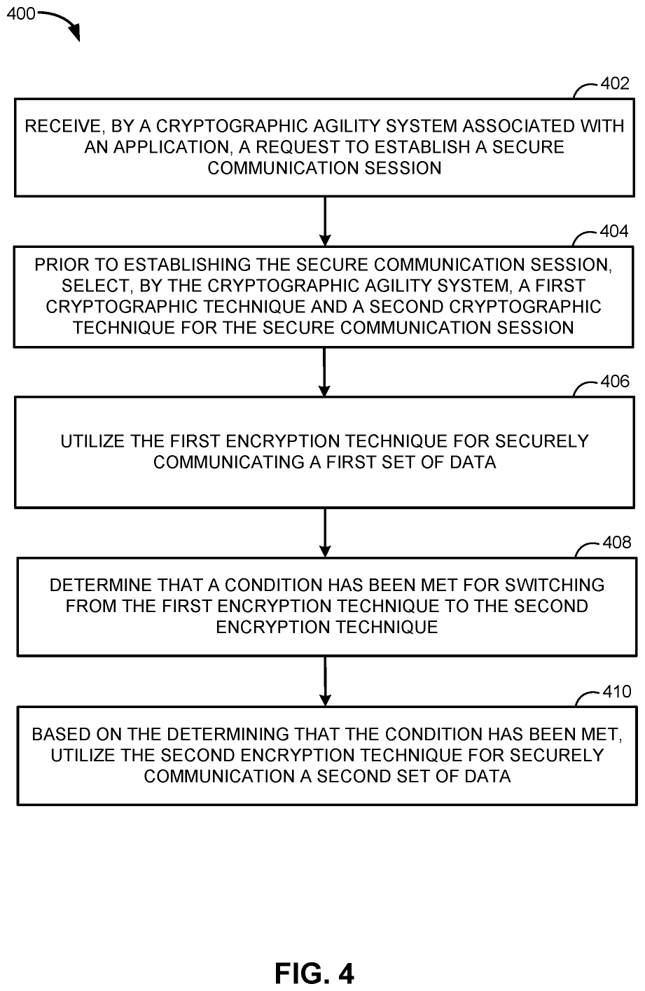

FIG. 4 depicts example operations 400 related to related to dynamic cryptographic technique selection according to embodiments of the present disclosure. For example, operations 400 may be performed by one or more components of the cryptographic agility system described above with respect to FIGS. 1-3.

Operations 400 begin at step 402, with receiving, by a cryptographic agility system associated with an application, a request to establish a secure communication session.

Operations 400 continue at step 404, with, prior to establishing the secure communication session, selecting, by the cryptographic agility system, a first cryptographic technique and a second cryptographic technique for the secure communication session.

Operations 400 continue at step 406, with, during the secure communication session, utilizing the first encryption technique for securely communicating a first set of data.

Operations 400 continue at step 408, with, during the secure communication session, determining that a condition has been met for switching from the first encryption technique to the second encryption technique.

Operations 400 continue at step 410, with based on the determining that the condition has been met, utilizing the second encryption technique for securely communication a second set of data.

Certain embodiments further comprise, prior to establishing the secure communication session, determining, by the cryptographic agility system, a first key for the first cryptographic technique and a second key for the second cryptographic technique. Other embodiments comprise, prior to establishing the secure communication session, determining, by the cryptographic agility system, a first key for the first cryptographic technique and, upon determining that the condition has been met for switching from the first encryption technique to the second encryption technique, determining, by the cryptographic agility system, a second key for the second cryptographic technique.

In some cases, determining that the condition has been met comprises determining that a time interval has elapsed, determining that a threshold amount of data has been communicated in the secure communication session, determining one or more characteristics of the second set of data, determining a change in contextual information related to a device, or receiving user input.

In certain embodiments, the first cryptographic technique and the second cryptographic technique comprise different cryptographic algorithms, while in other embodiments the first cryptographic technique and the second cryptographic technique comprise a same cryptographic algorithm with different keys.

Some embodiments further include determining that an additional condition has been met for returning to the first cryptographic technique and, based on the determining that the additional condition has been met, utilizing the first encryption technique for securely communication a third set of data.

Certain embodiments further comprise, based on the determining that the additional condition has been met, determining new keys for the first cryptographic technique and the second cryptographic technique.

Some embodiments further include determining that an additional condition has been met for selecting new cryptographic techniques and, based on the determining that the additional condition has been met, selecting, by the cryptographic agility system, a third cryptographic technique and a fourth cryptographic technique for the secure communication session.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—-CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of cryptographic agility, comprising:
receiving, by a cryptographic agility system associated with an application, a request to establish a secure communication session;
prior to establishing the secure communication session, selecting, by the cryptographic agility system, a first cryptographic technique and a second cryptographic technique for the secure communication session; and
during the secure communication session:
utilizing the first encryption technique for securely communicating a first set of data;
determining that a condition has been met for switching from the first encryption technique to the second encryption technique; and
based on the determining that the condition has been met, utilizing the second encryption technique for securely communication a second set of data.

2. The method of claim 1, further comprising, prior to establishing the secure communication session, determining, by the cryptographic agility system, a first key for the first cryptographic technique and a second key for the second cryptographic technique.

3. The method of claim 1, further comprising:
prior to establishing the secure communication session, determining, by the cryptographic agility system, a first key for the first cryptographic technique; and
upon determining that the condition has been met for switching from the first encryption technique to the second encryption technique, determining, by the cryptographic agility system, a second key for the second cryptographic technique.

4. The method of claim 1, wherein determining that the condition has been met comprises:
determining that a time interval has elapsed;
determining that a threshold amount of data has been communicated in the secure communication session;
determining one or more characteristics of the second set of data;
determining a change in contextual information related to a device; or receiving user input.

5. The method of claim 1, wherein:
the first cryptographic technique and the second cryptographic technique comprise different cryptographic algorithms; or
the first cryptographic technique and the second cryptographic technique comprise a same cryptographic algorithm with different keys.

6. The method of claim 1, further comprising:
determining that an additional condition has been met for returning to the first cryptographic technique; and
based on the determining that the additional condition has been met, utilizing the first encryption technique for securely communication a third set of data.

7. The method of claim 6, further comprising, based on the determining that the additional condition has been met, determining new keys for the first cryptographic technique and the second cryptographic technique.

8. The method of claim 1, further comprising:
determining that an additional condition has been met for selecting new cryptographic techniques; and
based on the determining that the additional condition has been met, selecting, by the cryptographic agility system, a third cryptographic technique and a fourth cryptographic technique for the secure communication session.

9. A system for cryptographic agility, comprising:
at least one memory; and
at least one processor coupled to the at least one memory, the at least one processor and the at least one memory configured to:
receive, by a cryptographic agility system associated with an application, a request to establish a secure communication session;
prior to establishing the secure communication session, select, by the cryptographic agility system, a first cryptographic technique and a second cryptographic technique for the secure communication session; and
during the secure communication session:
utilize the first encryption technique for securely communicating a first set of data;
determine that a condition has been met for switching from the first encryption technique to the second encryption technique; and
based on the determining that the condition has been met, utilize the second encryption technique for securely communication a second set of data.

10. The system of claim 9, wherein the at least one processor and the at least one memory are further configured to, prior to establishing the secure communication session, determine, by the cryptographic agility system, a first key for the first cryptographic technique and a second key for the second cryptographic technique.

11. The system of claim 9, wherein the at least one processor and the at least one memory are further configured to:
prior to establishing the secure communication session, determine, by the cryptographic agility system, a first key for the first cryptographic technique; and
upon determining that the condition has been met for switching from the first encryption technique to the second encryption technique, determine, by the cryptographic agility system, a second key for the second cryptographic technique.

12. The system of claim 9, wherein determining that the condition has been met comprises:
determining that a time interval has elapsed;
determining that a threshold amount of data has been communicated in the secure communication session;
determining one or more characteristics of the second set of data;
determining a change in contextual information related to a device; or receiving user input.

13. The system of claim 9, wherein:
the first cryptographic technique and the second cryptographic technique comprise different cryptographic algorithms; or
the first cryptographic technique and the second cryptographic technique comprise a same cryptographic algorithm with different keys.

14. The system of claim 9, wherein the at least one processor and the at least one memory are further configured to:
determine that an additional condition has been met for returning to the first cryptographic technique; and
based on the determining that the additional condition has been met, utilize the first encryption technique for securely communication a third set of data.

15. The system of claim 14, wherein the at least one processor and the at least one memory are further configured to, based on the determining that the additional condition has been met, determine new keys for the first cryptographic technique and the second cryptographic technique.

16. The system of claim 9, wherein the at least one processor and the at least one memory are further configured to:
determine that an additional condition has been met for selecting new cryptographic techniques; and
based on the determining that the additional condition has been met, select, by the cryptographic agility system, a third cryptographic technique and a fourth cryptographic technique for the secure communication session.

17. A non-transitory computer-readable medium storing instructions that, when executed by one or more processors, cause the one or more processors to:
receive, by a cryptographic agility system associated with an application, a request to establish a secure communication session;
prior to establishing the secure communication session, select, by the cryptographic agility system, a first cryptographic technique and a second cryptographic technique for the secure communication session; and
during the secure communication session:
utilize the first encryption technique for securely communicating a first set of data;
determine that a condition has been met for switching from the first encryption technique to the second encryption technique; and
based on the determining that the condition has been met, utilize the second encryption technique for securely communication a second set of data.

18. The non-transitory computer-readable medium of claim 17, wherein the instructions, when executed by one or more processors, further cause the one or more processors to, prior to establishing the secure communication session, determine, by the cryptographic agility system, a first key for the first cryptographic technique and a second key for the second cryptographic technique.

19. The non-transitory computer-readable medium of claim 17, wherein the instructions, when executed by one or more processors, further cause the one or more processors to:
prior to establishing the secure communication session, determine, by the cryptographic agility system, a first key for the first cryptographic technique; and
upon determining that the condition has been met for switching from the first encryption technique to the second encryption technique, determine, by the cryptographic agility system, a second key for the second cryptographic technique.

20. The non-transitory computer-readable medium of claim 17, wherein determining that the condition has been met comprises:
determining that a time interval has elapsed;
determining that a threshold amount of data has been communicated in the secure communication session;
determining one or more characteristics of the second set of data;
determining a change in contextual information related to a device; or receiving user input.
